(19) United States
(12) Patent Application Publication
(10) Pub. No.: US 2011/0247050 A1
(43) Pub. Date: Oct. 6, 2011

(54) METHOD OF PAIRING TERMINALS WITH EACH OTHER AND TERMINAL FOR THE SAME

(75) Inventors: Donghwan Son, Daejeon (KR); Jin-Mee Kim, Daejeon (KR); Shin-Young Ahn, Daejeon (KR); Sung-Won Yi, Daejeon (KR); Jong-Sung Kim, Daejeon (KR); Ji-Yong Kim, Daejeon (KR); Hyeon-Jin Kim, Daejeon (KR); Sung-Ho Im, Daejeon (KR); Seung-Jo Bae, Daejeon (KR); Kyoung Park, Daejeon (KR); Wan Choi, Daejeon (KR)

(73) Assignee: Electronics and Telecommunications Research Institute, Daejeon (KR)

(21) Appl. No.: 13/076,613

(22) Filed: Mar. 31, 2011

(30) Foreign Application Priority Data
Apr. 1, 2010 (KR) 10-2010-0029958

(51) Int. Cl. G06F 15/16; G06F 21/00

(52) U.S. Cl. 726/3; 709/227

(57) ABSTRACT

Provided is a method of pairing terminals with each other, and a terminal for the method. The method includes sensing a physical motion of a terminal caused by a user and outputting a sensing value, comparing a reception value received from an external terminal with the sensing value, and establishing a communication path with the external terminal according to the comparison result.

### CLAIM FOR PRIORITY

This application claims priority to Korean Patent Applications No. 10-2010-0029958 filed on Apr. 1, 2010 in the Korean Intellectual Property Office (KIPO), the entire contents of which are hereby incorporated by reference.

### BACKGROUND

1. Technical Field

Example embodiments of the present invention relate in general to a method of pairing terminals with each other, and more specifically to a method of pairing terminals with each other by synchronizing physical motions of at least one pair of terminals to establish a peer-to-peer (P2P) communication connection between the terminals, and a terminal for the method.

2. Related Art

In general, a wireless communication environment is convenient for installation and movement of devices, less limited in space, and thus provides far more convenience than a wired communication environment. Devices capable of wireless communication have unique physical addresses referred to as media access control (MAC) addresses, for example, a device ID, and transmit and receive data using these MAC addresses.

MAC addresses generally consist of a 3-byte vendor code and a 3-byte serial code, and are allocated to respective devices. In other words, all devices are distinguished from each other by vendor codes and serial codes of their MAC addresses. Meanwhile, wireless communication devices require pairing with a counterpart device to communicate with the counterpart device.

Conventionally, a physical method of storing the MAC address of a counterpart device in a memory using an input device has been used for pairing with the counterpart device. However, this method involves many processes for pairing between devices, and does not enable general users who do not use an input device to perform pairing.

Also, when pairing is wirelessly performed, a MAC address of the counterpart device is unknown. Thus, a pairing request signal and a pairing permission signal may be transmitted to all devices around the counterpart device, thereby interfering with the devices and causing the devices to malfunction.

### SUMMARY

Accordingly, example embodiments of the present invention are provided to substantially obviate one or more problems due to limitations and disadvantages of the related art.

Example embodiments of the present invention provide a method of pairing at least one pair of terminals with each other by synchronizing motions of the terminals.

Example embodiments of the present invention also provide a terminal for performing the method of pairing terminals with each other.

In some example embodiments, a method of pairing terminals with each other includes: sensing a physical motion of a terminal caused by a user and outputting a sensing value; comparing a reception value received from an external terminal with the sensing value; and establishing a communication path with the external terminal according to the comparison result.

In other example embodiments, a terminal includes: a sensing unit configured to output a sensing value from a sensing signal obtained by sensing a physical motion of the terminal caused by a user; a comparator configured to compare a reception value received from an external terminal with the sensing value and output the comparison result; and an authenticator configured to establish a communication path between the terminal and the external terminal according to the comparison result.

### BRIEF DESCRIPTION OF DRAWINGS

Example embodiments of the present invention will become more apparent by describing in detail example embodiments of the present invention with reference to the accompanying drawings, in which:

FIG. 1 is a block diagram showing a schematic constitution of a network system for to establishing a communication connection by pairing terminals with each other according to example embodiments of the present invention;

FIG. 2 is a schematic block diagram of the terminal shown in FIG. 1;

FIG. 3 is a flowchart illustrating an operation of pairing terminals with each other according to example embodiments of the present invention; and

FIGS. 4A and 4B are waveform diagrams according to an operation of pairing terminals with each other.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

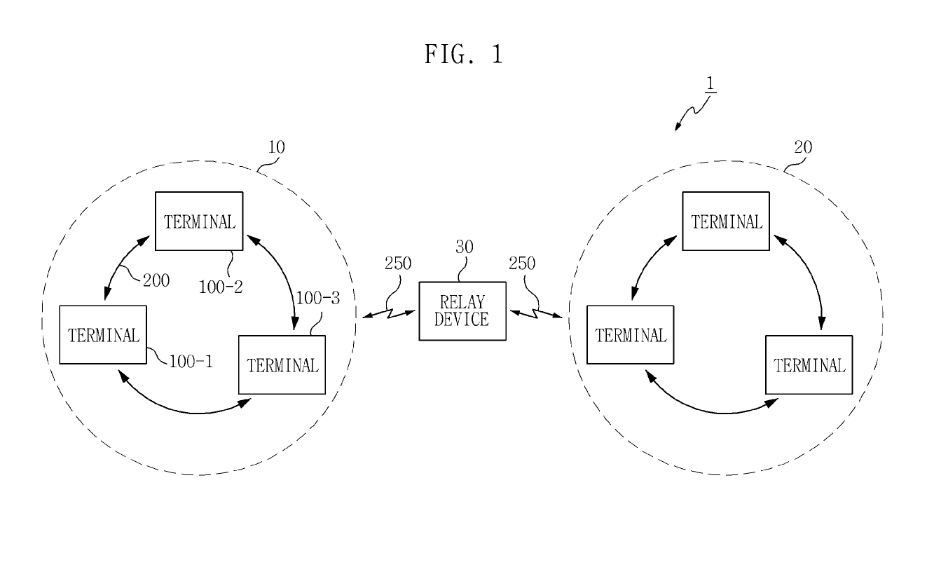

FIG. 1 is a block diagram showing a schematic constitution of a network system for establishing a communication connection by pairing terminals with each other according to example embodiments of the present invention.

Referring to FIG. 1, a network system 1 may include local networks 10 and 20 and a relay device 30 for connecting the local networks 10 with each other.

Each of the local networks 10 and 20 may include a plurality of terminals 100_1, 100_2 and 100_3 capable of communication.

For example, each of the terminals 100_1, 100_2 and 100_3 included in the one local network 10 can perform communication between authenticated terminals using a wireless local area network (LAN) 200.

Also, each of the terminals 100_1, 100_2 and 100_3 included in the one local network 10 and each terminal included in the other local network 20 may perform communication between authenticated terminals using the relay device 30 and a wireless wide area network (WAN) 250.

Meanwhile, the terminals 100_1, 100_2 and 100_3 included in the respective local networks 10 and 20 may be heterogeneous communication terminals such as a cellular phone, a smartphone, a personal digital assistant (PDA) phone, and a portable multimedia player (PMP).

Also, such a communication terminal may perform a pairing operation for authentication together with another communication terminal and then establish a communication connection to exchange data.

A pairing operation between at least one pair of communication terminals will be described in detail below with reference to drawings.

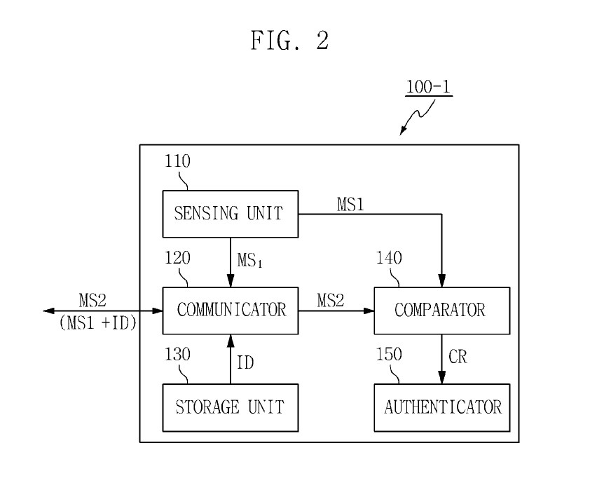

FIG. 2 is a schematic block diagram of the terminal shown in FIG. 1. Although one terminal is described below for convenience, other terminals may also have the same constitution.

Referring to FIGS. 1 and 2, one terminal (i.e., a first terminal) 100_1 may perform pairing to establish a communication connection with an external terminal in the same local network 10 or the other local network 20 via the relay device 30.

To this end, the first terminal 100_1 may include a sensing unit 110, a communicator 120, a storage unit 130, a comparator 140, and an authenticator 150.

The sensing unit 110 can sense a motion of the first terminal 100_1, for example, a physical motion of the first terminal 100_1 caused by a user, and output a sensing value MS1 according to the sensing result.

The sensing unit 110 may include various sensors, for example, a motion sensor, a direction sensor, and a touch sensor, and output the sensing value MS1 on the basis of a sensing signal output from these sensors.

Also, the sensing unit 110 may further include a converter (not shown) for converting an analog signal, that is, the sensing signal output from the sensors, into a digital signal, that is, the sensing value MS1.

The communicator 120 may transmit the sensing value MS1 output from the sensing unit 110 to the outside, that is, an external terminal in the same local network 10, or the relay device 30.

In this case, the communicator 120 may transmit unique information, that is, identification (ID) information ID, about the first terminal 100_1 stored in the storage unit 130 to be described below together with the sensing value MS1.

Also, the communicator 120 can receive a sensing value, that is, a reception value MS2, transmitted from an external terminal in the same local network 10 or the other local network 20.

In the storage unit 130, the ID information ID about the first terminal 100_1 may be stored. Additionally, ID information about the external terminal included in the reception value MS2 that the communicator 120 receives from the external terminal may also be stored in the storage unit 130.

The comparator 140 may compare the sensing value MS1 output from the sensing unit 110 with the reception value MS2 received by the communicator 120 and output a comparison result CR.

For example, when the sensing value MS1 is the same as the reception value MS2 within an error range, the comparator 140 may output a comparison result CR having a first level, that is, a high level. On the other hand, when the sensing value MS1 is not the same as the reception value MS2, the comparator 140 can output a comparison result CR having a second level, that is, a low level.

The authenticator 150 may perform authentication (pairing) between the first terminal 100_1 and the external terminal on the basis of the comparison result CR output from the comparator 140, and establish a communication connection between the first terminal 100_1 and the external terminal according to the authentication.

Consequently, the first terminal 100_1 may exchange data with the external terminal while communicating with the other terminal.

A pairing operation performed by the above-described terminal will be described in detail below with reference to the drawings.

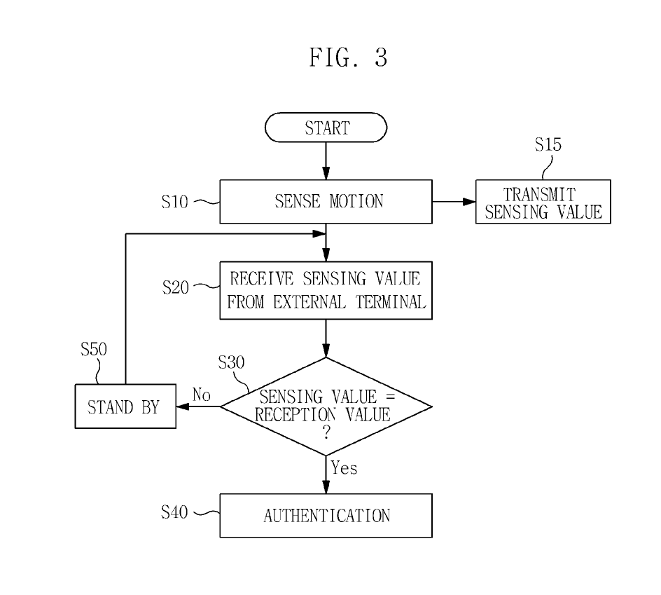

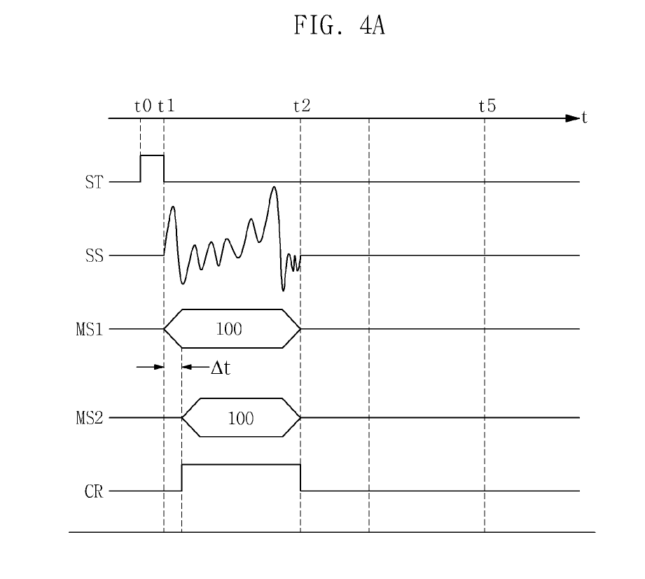

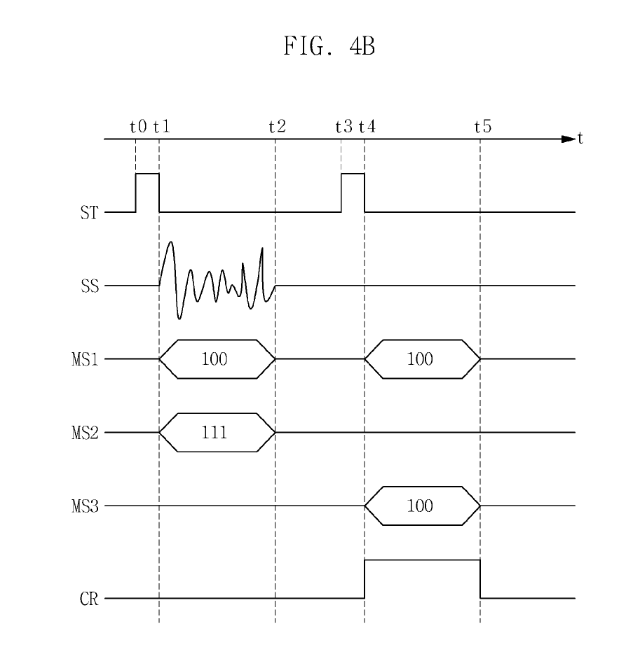

FIG. 3 is a flowchart illustrating an operation of pairing terminals with each other according to example embodiments of the present invention, and FIGS. 4A and 4B are waveform diagrams according to an operation of pairing terminals with each other.

In this example embodiment, an example in which one terminal, that is, the first terminal 100_1, performs pairing with an external terminal to establish a communication connection in the same local network 10 shown in FIG. 1 will be described.

However, the present invention is not limited to this example, and the first terminal 100_1 may perform pairing with an external terminal in the other local network 20 via the relay device 30 to establish a communication connection.

Referring to FIGS. 1 to 3, a user may operate the first terminal 100_1 in a pairing mode to establish a communication connection with an external terminal in the same local network 10 using the first terminal 100_1.

For example, the user may operate the first terminal 100_1 in the pairing mode by executing a network access program among various applications stored in the first terminal 100_1.

In this case, an external terminal to be connected for communication with the first terminal 100_1 may also be operated in the pairing mode. In other words, when the first terminal 100_1 is operated in the pairing mode by the user, the external terminal may also be operated in the pairing mode by another user in the same manner.

When the first terminal 100_1 operates in the pairing mode, the sensing unit 110 may sense a motion of the first terminal 100_1 and output a sensing value MS1 according to the sensed motion (S10).

The communicator 120 may transmit the sensing value MS1 output from the sensing unit 110 and ID information ID about the first terminal 100_1 stored in the storage unit 130 to the external terminal (S15).

The external terminal receiving the sensing value MS1 and the ID information ID from the first terminal 100_1 may transmit its own sensing value and ID information to the first terminal 100_1.

The first terminal 100_1 may receive the sensing value and ID information transmitted from the external terminal as a reception value MS2 (S20).

Subsequently, the first terminal 100_1 may compare its own sensing value MS1 with the reception value MS2 (S30).

For example, the comparator 140 of the first terminal 100_1 may determine whether the sensing value MS1 is the same as the reception value MS2 within an error range, and output a comparison result CR having a first or second level according to the determination result.

Referring to FIGS. 2 and 4A, when the user inputs an execution signal ST to operate the first terminal 100_1 in the pairing mode during a time from t0 to t1 on a time axis t, the sensing unit 110 of the first terminal 100_1 may sense a physical motion of the first terminal 100_1 and output a sensing signal SS during a time from t1 to t2 on the time axis t.

Subsequently, the sensing unit 110 may convert the sensing signal SS into a digital signal, thereby generating a sensing value MS1 of 100.

The generated sensing value MS1 may be transmitted to the external terminal to be connected for communication with the first terminal 100_1.

Meanwhile, the first terminal 100_1 may receive a reception value MS2 of 100 from the other terminal.

In this case, the first terminal 100_1 may receive the reception value MS2 with a predetermined time error Δt due to the network characteristics or terminal characteristics.

The comparator 140 may determine whether the sensing value MS1 is the same as the reception value MS2 and output the determination result.

When the sensing value MS1 and the reception value MS2 are 100, i.e. the same and the reception time error Δt of the reception value MS2 is within the permissible range, the comparator may determine that the sensing value MS1 is the same as the reception value MS2.

Then, the comparator 140 may output the comparison result CR having the first level.

Referring back to FIGS. 1 to 3, when the comparison result CR having the first level is output because the comparator 140 determines that the sensing value MS1 is the same as the reception value MS2, the authenticator 150 may perform mutual authentication between the first terminal 100_1 and the external terminal in response to the comparison result CR having the first level (S40).

The authenticator 150 may store the ID information about the external terminal included in the reception value MS2 in the storage unit 130 according to the mutual authentication.

Also, the authenticator 150 may establish a communication path between the first terminal 100_1 and the external terminal according to the mutual authentication, and thus the two terminals may exchange data with each other using the established communication path.

Therefore, the users of the terminal 100_1 and the external terminal perform pairing of their terminals by simply sharing the physical motion.

On the other hand, when the comparator 140 determines that the sensing value MS1 is not the same as the reception value MS2, the comparison result CR having the second level may be output.

In response to the comparison result CR having the second level, the authenticator 150 may stop mutual authentication between the first terminal 100_1 and the external terminal and cause the first terminal 100_1 to stand by for a predetermined time (S50).

Subsequently, the first terminal 100_1 may transmit the sensing value MS1 generated by the sensing unit 110 to another external terminal, and repeat the pairing operation from the step (S20) of receiving a sensing value from said another external terminal.

Referring to FIGS. 2 and 4B, when the user inputs the execution signal ST to operate the first terminal 100_1 in the pairing mode during the time from t0 to t1 on the time axis t, the sensing unit 110 of the first terminal 100_1 may sense a physical motion of the first terminal 100_1 to output a sensing signal SS and convert the sensing signal SS into a digital signal to generate the sensing value MS1 of 100 during the time from t1 to t2 on the time axis t.

The generated sensing value MS1 may be transmitted to the external terminal to be connected for communication with the first terminal 100_1.

Meanwhile, the first terminal 100_1 may receive a reception value MS2 of 111 from the external terminal during the time from t1 to t2 on the time axis t, and the comparator 140 of the first terminal 100_1 may compare the sensing value MS1 with the reception value MS2 to output the comparison result CR.

In this case, since the sensing value MS1 and the reception value MS2 differ from each other, the comparator 140 may output the comparison result CR having the second level. In response to the comparison result CR having the second level, the authenticator 150 may cause the first terminal 100_1 to stand by for a time from t2 to t3 on the time axis t.

Subsequently, when the execution signal ST is input again by the user during a time from t3 to t4 on the time axis t, the first terminal 100_1 may operate in the pairing mode and transmit the sensing value MS1 previously generated by the sensing unit 110 to another external terminal to be connected for communication with the first terminal 100_1 during a time from t4 to t5 on the time axis t.

Also, the first terminal 100_1 may receive a reception value MS2 of 100 from said another external terminal during the time from t4 to t5 on the time axis t, and the comparator 140 may compare the sensing value MS1 with the reception value MS2.

In this case, the comparator 140 may determine that the sensing value MS1 and the reception value MS2 are 100, i.e. the same. Thus, the comparator 140 may output the comparison result CR having the first level

The authenticator 150 may perform mutual authentication between the first terminal 100_1 and said another external terminal in response to the comparison result CR having the first level, and thus may establish a communication path between the first terminal 100_1 and said another external terminal. The two terminals may exchange data with each other using the established communication path.

A method of pairing terminals with each other and a terminal for the method according to example embodiments of the present invention can synchronize physical motions of at least one pair of terminals to establish a communication path between the terminals, thereby readily establishing the communication path between the terminals in a network.

While the example embodiments of the present invention and their advantages have been described in detail, it should be understood that various changes, substitutions and alterations may be made herein without departing from the scope of the invention.

What is claimed is:

1. A method of pairing terminals with each other, comprising:
sensing, at a terminal, a physical motion of the terminal caused by a user and outputting a sensing value;
comparing, at the terminal, a reception value received from an external terminal with the sensing value; and
establishing, at the terminal, a communication path to the external terminal according to the comparison result.

2. The method of claim 1, wherein the sensing value is generated based on a motion, a direction, or a touch of the terminal.

3. The method of claim 1, wherein the sensing value is outputted when the terminal operates in a pairing mode.

4. The method of claim 1, wherein the sensing value is transmitted together with identification (ID) information about the terminal to the external terminal.

5. The method of claim 1, wherein the comparing the reception value with the sensing value includes determining whether the reception value is the same as the sensing value within an error range and outputting the determination result.

6. The method of claim 1, wherein the establishing the communication path includes:
performing mutual authentication between the terminal and the external terminal when it is determined that the sensing value is the same as the reception value; and
establishing the communication path between the terminal and the external terminal on the basis of the mutual authentication.

7. The method of claim 6, wherein the establishing the communication path further includes:
comparing a reception value received from another external terminal with the sensing value when it is determined that the sensing value is not the same as the reception value; and
performing mutual authentication between the another external terminal and the to terminal according to the comparison result and establishing a communication path between the terminal and the another external terminal.

8. The method of claim 6, wherein the establishing the communication path further includes, when it is determined that the sensing value is not the same as the reception value, causing the terminal to stand by.

9. A terminal for performing pairing, comprising:
a sensing unit configured to output a sensing value from a sensing signal obtained by sensing a physical motion of the terminal caused by a user;
a comparator configured to compare a reception value received from an external terminal with the sensing value and output the comparison result; and
an authenticator configured to establish a communication path between the terminal and the external terminal on the basis of the comparison result.

10. The terminal of claim 9, wherein the sensing unit includes a motion sensor, a direction sensor, or a touch sensor.

11. The terminal of claim 10, wherein the sensing unit further includes a converter configured to convert the sensing signal and output the sensing value.

12. The terminal of claim 9, wherein the comparator determines whether the reception value is the same as the sensing value within an error range and outputs the determination result.

13. The terminal of claim 9, wherein the authenticator performs mutual authentication between the terminal and the external terminal and establishes the communication path on the basis of the mutual authentication when the comparator determines that the sensing value is the same as the reception value.

14. The terminal of claim 13, wherein the comparator compares a reception value transmitted from another external terminal with the sensing value and outputs the comparison result when the comparator determines that the sensing value is not the same as the reception value.

15. The terminal of claim 9, further comprising a communicator configured to transmit the sensing value to the external terminal or receive the reception value from the external terminal.
